(19) United States
(12) Patent Application Publication
(10) Pub. No.: US 2001/0012586 A1
(43) Pub. Date: Aug. 9, 2001

(54) Method to make nickel positive electrodes and batteries using same

(76) Inventors: Kuochih Hong, Troy, MI (US); Yee-Ming Lin, Chouzou (TW)

Correspondence Address: KUOCHIH HONG, 1790 Rollingwoods, TROY, MI, 48098, US

(21) Appl. No.: 09/776,354

(22) Filed: Feb. 2, 2001

Related U.S. Application Data
(63) Continuation-in-part of application No. 09/076,146, filed on May 11, 1998, now abandoned.
Application No. 09/076,146 is a continuation-in-part of application No. 08/553,756, filed on Oct. 23, 1995, now Pat. No. 5,733,680.
Application No. 09/076,146 is a continuation-in-part of application No. 08/661,078, filed on Jun. 10, 1996, now Pat. No. 5,695,530.
Application No. 09/076,146 is a continuation-in-part of application No. 08/789,947, filed on Jan. 27, 1997, now Pat. No. 5,766,799.

(51) Int. Cl. H01M 4/32; H01M 4/58; H01M 4/52

(52) U.S. Cl. 429/223; 429/218.2; 427/126.6

(57) ABSTRACT

This invention discloses a method to make a positive electrode and the nickel hydride battery using same. The positive electrode at least comprises a nickel hydroxide plus 1-15 wt. % of fine additive powders selected from the group consisting of Co/CoO, Ni, Cu, Zn, ZnO, C, Mg, Al, Mn, silver oxide, hydride, conductive polymer, and combinations thereof. Said positive electrode further comprises one, two or more additives, 0.01-10 wt. %, selected from the group of MgCl₂, CaCl₂, SrCl₂, SrF₂, BaCl₂, BaF₂, MgF₂, and other fluorides/chlorides of alkali metals, alkaline earth metals, Al, Y, Sn, Sb, Ag, transition metals, rare earth metals, and composite metal oxide/halide to improve the performance of said positive electrode at high temperature.

### CROSS-REFERENCE TO RELATED APPLICATIONS

This application is a continuation in part application of application U.S. patent application Ser. No. 09/076,146 filled on May 11, 1998 and now abandoned, which was a continuation in part application of application U.S. patent application Ser. No. 08/553,756 filed on Oct. 23, 1995, now U.S. Pat. No. 5,733,680, Ser. No. 08/661,078 filed on Jun. 10, 1996 now U.S. Pat. No. 5,695,530, and Ser. No. 08/789,947 filed on Jan. 27, 1997, which is pending.

### FIELD OF THE INVENTION

This invention relates to a method of manufacturing nickel positive electrodes in mass production and rechargeable hydride batteries using same. More specifically, this invention relates to a continuous mass production process to make high capacity pasted nickel electrodes for rechargeable nickel hydride batteries suitable for high temperature application.

### THE RELATED ART

There are several researchers reporting methods to produce nickel positive electrodes for nickel cadmium or hydride battery application. These prior arts are giving in U.S. Pat. Nos. 5,466,546; 5,348,822; 5,032,475; 4,985,318; 5,023,155; 4,975,035; 4,364,422; 4,844,999; 4,844,948; and 4,696,875. However, these prior arts only provide information to add additives in the electrode to increase the utilization of nickel oxide active material. In U.S. Pat. Nos. 5,132,177; 5,344,728; 6,027,834 and 5,446,543, the inventors suggested the use of NaOH in the electrolyte or the incorporation of the oxides of Al, Y, In, Sb, Ba, Ca, Be and rare earth metals in the positive electrolyte to improve the high temperature performance of the nickel hydride batteries. No information is given to make a pasted (non-sintered) high capacity nickel positive electrode in mass production using metal sponge (foam) as the substrate current collector. Furthermore, the addition of NaOH in KOH solution will decrease the rate capability substantially. A high capacity nickel positive electrode is needed in order to match a high capacity hydride electrode to make a high capacity nickel hydride battery, especially for a high temperature application up to 60-70° C. It requires the impregnation of a large amount of the nickel hydroxide into the substrate current collector. The loading of the active material into the pores of a metal sponge using a pasting method is not the same as the chemical or electrochemical impregnation method. Furthermore, it is not easy to load a substantial amount of active material into the pores of sponge substrate in the mass production process.

To solve these problems, the present invention provides a pasting mass production method to make a high capacity master nickel positive electrode using metal sponge (foam) or fiber as the substrate current collector, and high capacity nickel hydride batteries using same.

### SUMMARY OF THE INVENTION

This invention provides a method to manufacture pasted type nickel positive electrodes in mass production and rechargeable hydride batteries using same. More specifically, this invention relates to a continuous mass production process to make a high capacity pasted master nickel electrode for rechargeable hydride batteries, especially sealed hydride batteries for high temperature up to 80° C. The battery, according to this invention, is composed of a container, a positive electrode, a negative electrode comprising of at least one, two or more hydrogen storage electrode materials and/or their hydrides, a separator positioned between the positive and negative electrodes, and an electrolyte in the container and in contact with the positive and negative electrodes and the separator. The positive electrode is composed of metal oxide(s) as the active material, preferably nickel oxide(s). The separator is composed of a body selected from nylon, polypropylene, polysulfone or combinations thereof. The electrolyte is composed of an alkaline solution. The container is made of either metal or plastic materials.

The metal oxide positive electrode of this invention is a pasted type and has a high electrochemical capacity of from 0.550 to 0.750 AH/cc . According to this invention, the making of a pasted master nickel electrode at least consists of the following steps:

(1) providing a sheet (roll) of the metal sponge (foam) or fiber as the substrate current collector;

(2) preparing the slurry of electrode active material(s);

(3) pressing metal sponge or fiber to the right thickness by a first roller assembly;

(4) providing an impregnation machine;

(5) providing a slurry delivery system;

(6) impregnating the slurry of the active material into the sponge or fiber substrate current collector to make a wet nickel electrode;

(7) drying the wet nickel electrode in a dryer system to have a dried master nickel electrode; and

(8) pressing the dried master nickel electrode to the right thickness by a final roller system.

Wherein the positive electrode active material comprises a metal oxide, preferably a nickel oxide plus 1-15 wt. % cobalt/cobalt oxide; up to 5 wt. % organic polymer such as MC, HPMC, CMC, polyox, or a combination thereof as the binder; up to 15 wt. % of fine powder selected from the group consisting of Ni, Cu, Zn, ZnO, C, Mg, Al, Mn, silver oxide, iodine, iodide (LiI, NaI, KI, etc.), hydride, conductive polymer and combinations thereof. Furthermore, the positive electrode is consisting of 0.05 to 10 wt. %, preferably 0.5 to 5 wt. %, of one, two, three or more of the additives selected from the metal halides, oxide, and combination thereof. The metal halides and oxides includes the fluorides, chlorides and oxides of Li, Na. K, Rb, Cs, Be, Mg, Ca, Sr, Ba, Al, B, Bi, Sb, Y, Ag, Ti, Zr, V, Nb, Cr, Mn, Mo, Zn, Cu, Ni, Co and rare earth metals to improve the high temperature performance. Examples of said metal halides include MgCl₂, MgF₂, CaCl₂, CaF₂, SrCl₂, SrF₂, BaCl₂, BaF₂, ZnCl₂, ZnF₂, AlCl₃, AlF₃, KCl, KF, NaCl, NaF, LiCl, LiF, BiCl₃, NaAlF₆ and LiAlF₄. The cobalt oxide is chosen from: CoO, Co(OH)₂, Co₃O₄ or a combination thereof, preferably CoO and/or Co(OH)₂. Initially, the nickel hydroxide powder is used and it mixes homogeneously with additives such as cobalt oxide, Zn/ZnO. Alternatively, the nickel hydroxide powder may form a solid solution with one or more of said additives. The substrate current collector of the positive electrode is the sponge (foam) or fiber of nickel or nickel-plated steel.

It is the major objective of the present invention to provide a manufacturing method to make a pasted type, high capacity nickel electrode for rechargeable battery application, especially for nickel hydride batteries for a high temperature application. This is a continuous process and can make up to 500 ft without interruption.

The advantages, features, and other objects of the present invention will become clear from the following detailed description.

### DETAILED DESCRIPTION OF THE INVENTION

This invention provides a pasting method to manufacture nickel positive electrodes in mass production and rechargeable hydride batteries using same. More specifically, this invention relates to an continuous mass production method to make a high capacity pasted master nickel electrode for rechargeable hydride batteries, especially sealed hydride batteries suitable for high rate charge and overcharge.

In a nickel-hydride battery, the electrochemical reactions are as follows:

At the positive electrode (Nickel electrode):

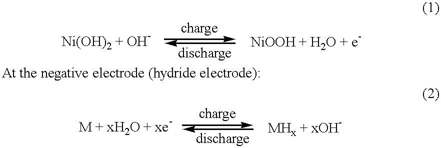

where M and MHₓ are the hydrogen storage material and its hydride, respectively. The hydride in equation (2) is related to hydrogen equilibrium pressure shown in equation (3):

MHₓ [symbol] M+x/2H₂ (3)

During charging, as shown in Equations 3 and 4, hydroxide ions pass through the separator via the electrolyte from the negative electrode to the positive electrode, and water molecules pass through the separator via the electrolyte from the positive electrode to the negative electrode. During discharge, wherein a load is placed across the positive and negative terminals, water molecules pass through the separator via the electrolyte, from the negative electrode to the positive electrode, and hydroxide ions pass through the separator via the electrolyte, from the positive electrode to the negative electrode.

During overcharge, water electrolysis will occur. Thus, oxygen will be generated at the positive electrode and hydrogen gas will be generated at the negative electrode. During overdischarge, water electrolysis will also occur. Thus, hydrogen gas will be generated at the positive electrode and oxygen will be generated at the negative electrode. For a positive limited hydride cell, the electrochemical reactions can be expressed as the following equations:

OVERCHARGE (positive limited cell)

At positive electrode:

y/OH₋ [symbol] y/2H₂O+y/4O₂+ye⁻ (4)

At negative electrode:

MHₓ+yH₂O+ye⁻ [symbol] NH_{x+y}+yOH⁻ (5a)

(ideal case)

y/4O₂+MH_{x+y} [symbol] MHₓ+y/2 H₂O (5b)

(general case)

z/2O₂+MH_{x+y} [symbol] MH_{x+y-2z}O_{z}+zH₂ (5c)

OVERDISCHARGE (negative precharged cell)

At positive electrode:

mH₂O+me⁻ [symbol] mOH⁻+m/2H₂ (6)

At negative electrode:

MH_{q}+mOH⁻ [symbol] MH_{q-m} +mH₂O+me⁻ (7a)

MH_{q-m}+m/2H₂ [symbol] MH_{q} (7b)

During overcharge, in a sealed cell, if the oxygen gas does not recombine with hydrogen (Eq. 5b) or the recombination rate is poor, the internal pressure will increase and vent out through the safety valve. The electrolyte will then be lost and cell life is consequently shortened. Other factors, such as poor charging efficiency, will also increase the internal pressure of the cell.

According to this invention, the battery is composed of a container, a positive electrode, a negative electrode comprising of hydrogen storage electrode materials and/or their hydrides, a separator positioned between the positive and negative electrodes, and an electrolyte in the container and in contact with the positive and negative electrodes and the separator. The positive electrode is composed of metal oxide(s) as the active material, preferably nickel oxide(s). The separator is composed of a body selected from nylon, polypropylene, polysulfone or combinations thereof. The electrolyte is composed of an alkaline solution. The container is made of either metal or plastic materials. The negative electrode is a hydrogen storage hydride electrode which is composed of at least one, two or more hydrogen storage electrode alloy(s) having compositions represented by AₐB_{b}C_{c}D_{d}Eₑ . . . , where the set of elements: A, B, C, D, E, . . . is composed of nickel and at least four other elements chosen from the group consisting of Mg, Ti, V, Cr, Mn, Fe, Co, Ni, Cu, Al, Y, Zr, Nb, Pd, Ag, Mo, Ca, Si, C, Cu, Ta, Ca, rare earth metals, B, Hf, Sc, Zn, Sb, W, Sn, N, O, Ge, Ga, the alkali metals, P, and S; where the amount of nickel in the alloy AₐB_{b}C_{c}D_{d}Eₑ . . . is 34 to 80 at. %, preferably more than 47 at. %; where the hydrogen storage electrode alloy AₐB_{b}C_{c}D_{d}Eₑ . . . has a heat of hydride formation, Hₕ, in a range of between −2.00 and −12.50 Kcal/mole H, preferably between −2.50 and −8.50 Kcal/mole H; where the heat of hydride formation, Hₕ is defined by:

Hₕ=(aHₕ(A)+bHₕ(B)+cHₕ(C)+dHₕ(D)+eHₕ(E)+ . . .)/(a+b+c+d+e+ . . .)+K (8)

where Hₕ(A), Hₕ(B), Hₕ(C), Hₕ(D), Hₕ(E) . . . are the heats of hydride formation of the elements A, B, C, D, E, . . . , respectively, in units of Kcal/mole H, where the heat of hydride formation of the elements in units of Kcal/mole H, is given as: Hₕ(Mg)=−9.0, Hₕ(Ti)=−15.0, Hₕ(V)=−7.0, Hₕ(Cr)=−1.81, Hₕ(Mn)=−2.0, Hₕ(Fe)=4.0, Hₕ(Co)=3.5, Hₕ(Ni)=1.8, Hₕ(Al)=−1.38, Hₕ(Y)=−27, Hₕ(Zr)=−19.5, Hₕ(Nb)=−9.0, Hₕ(Pd)=−4.0, Hₕ(Mo)=−1.0, Hₕ(Ca)=−21.0, Hₕ(Si)=−1.0, Hₕ(C)=−1.0, Hₕ(Cu)=2.0, Hₕ(Ta)=−10.0, Hₕ(rare earth metals)=−27.0, Hₕ(Li)=−21.0, Hₕ(Na)=−13.4, Hₕ(K)=−13.7, Hₕ(Rb)=−12.5, Hₕ(B)=2.83, Hₕ(Sn)=2.05, Hₕ(Sb)=5.5, Hₕ(Hf)=−20.2, Hₕ(Sc)=−28.9, Hₕ(Zn)=−1.2, Hₕ(Ag)=1.0, Hₕ(S)=−1.0, Hₕ(N)=−0.5, Hₕ(W)=−0.50, and Hₕ(P)=−0.30; where K is a constant related to the heat of formation of the alloy AₐB_{b}C_{c}D_{d}Eₑ . . . and the heat of minxing of the hydrides AH, BH, CH, DH, EH, . . . , having a values between −1.50 and 0.5 Kcal/mole. For practical purpose, K is set to be 0.

According to this invention, a hydride negative electrode is composed of one, two or more hydrogen storage electrode alloys, single phase or multiphase, selected from the group of the ABₓ-alloy including AB₂-, AB₅-type alloy(s) and/or combinations thereof.

The multicomponent alloys of this invention, such as the five- or more-element materials, can be Ti/Zr based and/or rare earth-based alloys. The microstructure of said hydrogen storage alloy can be single phase or multiphases including polycrystalline, microcrystalline, amorphous or the mixtures. Furthermore, the crystal structure of said hydrogen storage alloy can be regular or distorted bcc, fcc, hcp, hex and the combinations thereof. Examples of these structures include A3,B2, C1, C14, C15, C16, C23, C36, D2_{d}, E9₃.

The Ti/Zr based hydrogen storage electrode alloy as the active material is represented by:

AₐB_{b}Ni_{c}D_{y}MₓR_{z}

where A is at least one or two elements selected from the group consisting of Ti, Zr, and Hf; B is at least one element selected from the group consisting of Mg, Al, V, Mn, Nb, Si, Pd, and Ag; D is at least one element selected from the group consisting of Cr, Mn, Fe, Co, Cu, Zn, Mo, W, Sn and Sb; M is at least one element selected from the group consisting of alkali metals, P, and S; R is at least one element selected from the group consisting of C, B, Ca, Bi, Sb, Y, Sc, Ta, Hf, N, 0, Ga, Ge, Te, Mm (rare earth metal including mischmetal); and where the atomic mole ratios a, b, c, x, y, and z are defined by:

0.01≦a≦0.85, 0.01≦b≦0.65, 0.02≦c≦0.80, 0≦x≦0.30, 0≦y≦0.30, 0≦z≦0.30 and a+b+c+x+y+z=1.00; preferably, 0.30≦a≦0.65, 0.02≦b≦0.45, 0.10≦c≦0.65. 0≦x≦0.15, 0≦y≦0.15, 0≦z≦0.15 and a+b+c+x+y+z=1.00.

The rare earth metal-based hydrogen storage electrode alloy as the active material is represented by the composition:

LnₐNi_{c}D_{y}MₓR_{z}

where Ln is rare earth metal or mischmetal, D is at least one element selected from the group consisting of Co, Mo, Sb, W, and Sn; M is at least one element selected from the group consisting of Mn, Zn, Cu, Cr, Fe, Al, Mg, Ca, and Be; R is at least one element selected from the group consisting of alkali metals, Ti, Zr, Y, Yb, Te, Hf, Ta, P, S, Si, Ge, Ga, B, O, and S; and where the atomic mole ratios a, c, x, y, and z are defined by: 0.01≦a≦0.35, 0.35≦c≦0.85, 0≦x≦0.20, 0≦y≦0.20, 0≦z≦0.20 and a+c+x+y+z=1.00; preferably, 0.08≦a≦0.25, 0.40≦c≦0.65, 0≦x≦0.15, 0≦y≦0.10, 0≦z≦0.10.

To make a high capacity rechargeable alkaline battery, a high capacity nickel positive electrode is needed. The metal oxide positive electrode of this invention is a pasted type and has an electrochemical capacity of from 0.550 to 0.750 AH/cc. Wherein the positive electrode comprises mainly nickel oxide fine powder (1-20 micrometers) as active agent, 0.02-5.0 wt. % organic polymer such as MC, HPMC, CMC, polyox or combination thereof as the binder; 1-15 wt. % of fine additive powders selected from the group consisting of cobalt oxide, Ni, Co, Cu, Zn, ZnO, C, Mg, Al, Mn, silver oxide, iodine, iodide (LiI, NaI, KI, etc.), hydride, conductive polymer, and combinations thereof. The cobalt oxides, which are good for improving charging efficiency but not good for high temperature performance, are chosen from: CoO, Co(OH)₂, Co₃O₄ or the combination thereof, preferably CoO and/or Co(OH)₂. Ni(OH)₂ may form a solid solution with one or more of said additives before or during electrode preparation.

Furthermore, the positive electrode is consisting one, two or more of other additives, 0.01-10wt %, selected from the metal halides, metal oxide, metal sulfides, and combination thereof to improve the high temperature performance, wherein said metal is selected from the group of alkali metals, alkaline earth metals, rare earth metals, transition metals, aluminum, copper, zinc, yttrium, indium and antimony. The metal halides and oxides includes the fluorides, chlorides and oxides of Li, Na. K, Rb, Cs, Be, Mg, Ca, Sr, Ba, Al, B, Bi, Sb, Y, Ag, Ti, Zr, V, Nb, Cr, Mn, Mo, Zn, Cu, Ni, Co and rare earth metals/mischmetals. Examples of said metal halides include CaCl₂, CaF₂, SrCl₂, SrF₂, BaCl₂, BaF₂, MgCl₂, MgF₂, ZnCl₂, ZnF₂, AlCl₃, AlF₃, KCl, KF, NaCl, NaF, LiCl, LiF, BiCl₃, NaAlF₆, LiAlF₄, composite metal oxide/halide; preferably mischmetal oxide/chloride, calcium oxide/chloride, manganese oxide/chloride, zinc oxide/chloride, bismuth-based salt, and composite oxide such as Ti/Sr oxide, Li/Ni oxide Li/Co oxide, Li/Ni/Co oxide, and Li/Mn oxide. Nickel hydroxide powder can mix homogeneously with said additives and/or may form a solid solution with one or more of said additives before or during electrode preparation.

According to this invention, the method is a continuous process and can make a roll of the master nickel electrode at least up to 1000 ft without interruption. The making of a pasted master nickel electrode consists of at least the following steps:

(1) providing a sheet (roll) of the metal sponge (foam) or fiber as the substrate current collector;

(2) preparing the slurry of electrode active material;

(3) pressing the substrate current collector: metal sponge or fiber to the right thickness by a first roller press assembly;

(4) providing an impregnating machine;

(5) providing a slurry delivery system;

(6) impregnating the slurry of the active material into the sponge substrate current collector to make a wet nickel electrode;

(7) drying the wet nickel electrode in a dryer system to have a dried master nickel electrode; and

(8) pressing the dried master nickel electrode to the right thickness by a final roller press system.

The substrate current collector of the positive electrode is the sponge (foam) or fiber of nickel or nickel-plated steel. Wherein the substrate (metal sponge/foam or fiber) is made of nickel or nickel plated steel, preferably nickel sponge (foam). The size of the substrate is 1.2-3.0 mm thick and 50-800 mm wide, preferably 1.30-1.70 mm thick and 100-500 mm wide. The pore size of the substrate is 50-130 ppi, preferably 70-120 ppi.

Wherein the first roller press assembly is composed of twin metal or plastic rollers. The size of the rollers is between 100 mm. and 500 mm in diameter, preferably 150-250 mm and 100 to 900 mm in length, preferably 200-600 mm. The gap of the rollers is adjustable.

Wherein the impregnation machine is a two-plate assembly which is made of metal such as stainless steel and aluminum, or plastic material such as PVC, polypropylene, polysulfone and polyamide. The machine comprises one slot used as the inlet and outlet for the (sponge) substrate, one inlet and one or more outlet(s) for the slurry, and two or more paths (reservoir spaces) which deliver the slurry evenly throughout the sponge or fiber substrate. The position of the impregnation machine is such that the inlet for the sponge or fiber substrate is in the bottom and the outlet is on the top. There is a blade on the top part of the slot to smoothly remove the slurry remaining on the both faces of the substrate.

Wherein the slurry delivery system is composed of at least a slurry tank and a metering pump that preferably includes a screw-type feeding system to control the slurry feeding rate. The slurry tank contains the slurry of the active material of the nickel electrode. There is a metal or plastic hose/pipe connecting the tank and the inlet of the metering pump and another metal or plastic hose/pipe connecting the tank and the (slurry) outlet of the impregnation machine. There is another metal or plastic hose/pipe connecting the outlet of the metering pump and the (slurry) inlet of the impregnation machine.

Wherein the last roller press assembly used to press the dried nickel electrode is composed of one or two set(s) of twin metal rollers; the size of the rollers is between 200 mm. and 500 mm in diameter, preferably 250-400 mm; and 200 to 900 mm in length, preferably 300-500 mm. This roller press can provide pressure up to 300 tons through a hydraulic system.

Wherein the slurry comprises of 50-80 wt. % positive electrode active material, mainly Ni(OH)₂ powder plus additives, 20-50 wt. % of pure water, and 0.02-5 wt. % organic binder selected from: MC, HPMC, CMC, polyox or combination thereof. Relative to said active material Ni(OH)₂, said slurry also consists of 1-15 wt. % cobalt oxide and 0-15 wt. % of other additives selected from the group consisting of Ni, Co, Cu, Zn, ZnO, C, Mg, Al, Al₂O₃, Mn, iodine, iodide (LiI, NaI, KI, etc.), hydride, conductive polymer, metal halides, oxide, and combination thereof. Furthermore, relative to said active material Ni(OH)₂, said slurry comprises metal halides, sulfides and oxides selected from the fluorides, chlorides, bromides and oxides of Li, Na. K, Rb, Cs, Be, Mg, Ca, Sr, Ba, Al, B, Bi, Sb, Y, Ag, Ti, Zr, V, Nb, Cr, Mn, Mo, Zn, Cu, Ni, Co and rare earth metals. The addition of said metal halides, sulfides and oxides will improve the performance of the positive electrode and therefore the battery made at high temperature up to 80° C. The amount of said metal halides, sulfides and oxides is 0.05-10 wt. %, preferably 0.1-5.0 wt. % relative to said active material Ni(OH)₂. When the amount is less than 0.05%, it is not effectively to improve the high temperature performance. When the amount is above 10 wt. %, it will reduce the actual utilization of the electrode and the capacity. Examples of said metal halides and oxides includes CaCl₂, CaF₂, CaBr₂, SrCl₂, SrF₂, SrBr₂, BaCl₂, BaF₂, BaBr₂, MgCl₂, MgF₂, MgBr₂, ZnCl₂, ZnF₂, ZnBr₂, AlBr₃, AlCl₃, AlF₃, KCl, KF, KBr, NaCl, NaF, NaBr, LiF, LiCl, LiBr, BiCl₃, NaAlF₆ and LiAlF₄. Said additives mix together homogeneously with active nickel oxide or may form solid solution in the body of nickel oxide powders before or during the slurry preparation. Furthermore, a 0.1 to 3 wt. % of alkaline solution may be added during the slurry preparation.

According to this invention, in the master electrode making process, the sheet (roll) of substrate (sponge/foam or fiber), having a thickness of 1.2-3.0 mm thick and 50-800 mm wide, preferably 1.30-1.70 mm thick and 100-500 nun wide, is first delivered manually or automatically at a rate up to 5 meters per minute to the first roller press system. The substrate is pressed to a right thickness in a range between 1.00 mm to 1.55 mm, preferably 1.25 to 1.45 mm. This preliminary pressing is needed to make sure that the final thickness of the electrode is within the suitable range and that the surface of the substrate is smooth and has no sharp edges. After preliminary pressing, the substrate current collector is moving to the impregnation machine where the slurry of the active material of the nickel electrode is continuously fed in from the slurry delivery system in a suitable feeding rate. When the substrate is moving through the slot in the impregnation machine, the slurry in the (slurry) paths inside the machine is forced to impregnate into the pores of the substrate. Extra slurry is recycled back to the slurry tank through the (slurry) outlet of the machine and a returning hose. As the substrate impregnated with the slurry is leaving the impregnation machine, the extra slurry still remaining on the surface of the substrate is wiped out smoothly by the blade located on the top part (the outlet) of the slot of the machine. Thus, a wet nickel electrode is made. The thickness of the wet nickel electrode is about 1.05 mm to 1.58 mm, preferably 1.25 to 1.48 mm. The impregnation process can also be done by using a partial vacuum in the slurry outlet side. The vacuum also serves as a force to recycle the slurry back to the slurry tank.

The wet nickel electrode then moves to a dryer system (chamber). The heat is generated by infrared heating or resistance heating. The temperature is controlled in the range of 70-200° C., preferably 80-150° C. To increase the drying efficiency, a circulating unit is provided to remove the water vapor out of the drying chamber. The wet electrode is dried through several heating zones in this dryer system. The dried master nickel electrode is thus obtained. The dried master electrode has a thickness of 1.02 mm to 1.56 mm, preferably 1.24 to 1.46 mm. The electrode will be pressed further by a final roller press to reduce the thickness to 60 -95 mm, preferably 65-90 mm to fit a particular cell size. The dried, pressed nickel electrode has a capacity of 0.550 to 0.750 AH/cc.

The method of making the master nickel electrode, according to this invention, is a continuous process and can be automatic. The production rate is up to 5 m/min (meter per minute).

For cell assembly, the method (process) further comprises the following steps: (1) cut the master nickel electrode to the small size suitable for a particular size of cell, (2) clean and remove the active material from one or more spot(s) on the cell-size electrode by various methods, preferably by ultrasonic cleaning, (3) attach one or more nickel or nickel plated metal tap(s) to the clean spot(s) on each of the cell-size electrodes by spot welding or ultrasonic welding.

Furthermore, the cell-size electrodes can be coated with a thin layer of PTFE or conductive polymer by dipping into the PTFE or conductive polymer solution. The cell-size nickel electrode with or without coating has a capacity of 550-750 mAH/cc and is ready to be used for cell assembly.

A matching size of hydride electrode is provided. The separator is cut of a similar size and is placed between the negative and positive electrodes to electrically separate them. The positive and negative electrodes with separator in between is placed in a container. The electrolyte is added. The container is made of either a metal such as nickel-plated steel or plastic material such as PVC, polypropylene, polysulfone and polyamide. The separator is composed of a porous body of insulator film or thin sheet of organic or inorganic material selected from the group consisting of polyamide (such as nylon), polypropylene, polyethylene, polysulfone, PVC. The thickness of separator is from 0.03 mm to 2.00 mm, preferably from 0.05 mm to 0.50 mm. The electrolyte is composed of alkaline solution, preferably KOH solution with concentration from 20 to 45 wt. % (preferable 30-42 wt. %) plus 0 to 10 wt. % of LiOH. The addition of NaOH (0-80% vs. KOH) in the electrolyte will improve the charging efficiency at high temperature. Suitable amounts (0-10 wt. %) of other chemicals such as an alkali halide, Ca(OH)₂, Mg(OH)₂, Sr(OH)₂, Be(OH)₂, ZnO, Al₂O₃ or the combinations thereof can also be added to enhance the high temperature performance. The amount of the electrolyte is 0.5-1.8 cc/AH, preferably 1.00-1.65 cc/AH of cell to be made.

In making a sealed cell, the hydrogen storage electrode of this invention should be activated and precharged before or after making a seal battery. The hydrogen storage hydride electrode may be coated with a layer selected from the group of PTFE, Ni, Al, Cu, Raney nickel, and the combination thereof before being used to make a cell to enhance the performance.

According to this invention, a sealed cell made thus has a high capacity, low internal resistance, high charging efficiency, fast oxygen recombination, high rate capability, low internal pressure and long life.

### EXAMPLE 1

According to this invention, various master pasted nickel positive electrodes having different additive were made. Said positive electrodes were combined with suitable hydride negative electrodes to make various sealed NiMH L-A size cells having a capacity of 3700 mAH/cc. The cells were charged and discharged at the same temperature (at 25° C. and 60° C.) at 2 A current. The results are given in Table 1. For comparison, blank cells which just contain Ni(OH)₂ and cobalt oxides and not contain the additive halide and/or other oxide in the positive electrodes were also made and tested. The results are also given in Table 1. Clearly, the additives of this invention improve the high temperature substantially.

TABLE 1
Capacity of L-A NiMH Cells Charged and discharged at 2A current

| Additives | % (Capacity at 60° C. vs. capacity at 25° C.) |
|---|---|
| Blank | 41 |
| 3% CaF₂ | 64 |
| 1% CaF₂ | 50 |
| 3% KF | 55 |
| 1% KF + 2% CaCl₂ | 78 |
| 4% KCl | 60 |
| 2% KCl | 58 |
| 3% AlCl₃ | 59 |
| 2% CaCl₂ + 1% Co | 86 |

### EXAMPLE 2

According to this invention, various master pasted nickel positive electrodes having different additive were made. Said positive electrodes were combined with suitable hydride negative electrodes to make various sealed NiMH AAA-cells having a capacity of 700 mAH/cc. The cells were charged and discharged at the same temperature (at 25° C. and 60° C.) at 1 C-rate current. The results are given in Table 2. For comparison, blank cells which just contain Ni(OH)₂ and cobalt oxides and not contain the additive halide and/or other oxide in the positive electrodes were also made and tested. The results are also given in Table 2. Clearly, the additives of this invention improve the high temperature substantially.

TABLE 2
Capacity of AAA NiMH Cells Charged and discharged at 1C-rate

| Additives | % (Capacity at 60° C. vs. capacity at 25° C.) |
|---|---|
| Blank | 55 |
| 3% CaF₂ | 74 |
| 1% CaF₂ | 60 |
| 3% KF | 62 |
| 1% KF | 58 |
| 4% KCl | 80 |
| 2% KCl | 75 |
| 3% MgCl₂ | 68 |
| 0.5% MgCl₂ | 56 |
| 3% CaCl₂ | 85 |
| 1% CaCl₂ | 74 |
| 3% AlCl₃ | 69 |
| 3% NaAlF₆ | 74 |
| 2% CaCl₂ + 1% AlCl₃ | 86 |

What is claimed is:

1. A method to make a high capacity pasted nickel electrode, wherein said method comprises the steps of:
(1) providing a sheet (roll) of the metal sponge (foam) or fiber as the substrate current collector;
(2) preparing the slurry of electrode active material;
(3) pressing the substrate current collector: metal sponge or fiber to the right thickness by a first roller press assembly;
(4) providing an impregnating machine;
(5) providing a slurry delivery system;
(6) impregnating the slurry of the active material into the sponge substrate current collector to make a wet nickel electrode;
(7) drying the wet nickel electrode to have a dried master nickel electrode; and
(8) pressing the dried master nickel electrode to the right thickness by a final roller press assembly;
wherein said slurry comprises of 50-80 wt. % positive electrode active material, mainly Ni(OH)₂ powder plus additives, 20-50 wt. % of pure water, and 0.02-5 wt. % organic binder selected from: MC, HPMC, CMC, polyox or combination thereof; relative to said active material Ni(OH)₂, said slurry, also comprises 1-15 wt. % cobalt oxide and 0-15 wt. % of other additives selected from the group consisting of Ni, Co, Cu, Zn, ZnO, C, Mg, Al, Al₂O₃, Mn, iodine, iodide (LiI, NaI, KI, etc.), hydride, conductive polymer, metal halides, oxide, and combination thereof; furthermore, said slurry comprises metal halides, sulfides and oxides selected from the fluorides, chlorides, bromides and oxides of Li, Na. K, Rb, Cs, Be, Mg, Ca, Sr, Ba, Al, B, Bi, Sb, Y, Ag, Ti, Zr, V, Nb, Cr, Mn, Mo, Zn, Cu, Ni, Co and rare earth metals, and composite metal oxide/halide to improve the performance of said positive electrode at high temperature.

2. A method of claim 1, wherein said metal fluorides and chlorides are CaCl₂, CaF₂, SrCl₂, SrF₂, BaCl₂, BaF₂, MgCl₂, MgF₂, ZnCl₂, ZnF₂, AlCl₃, AlF₃, KCl, KF, NaCl, NaF, LiCl, LiF, BiCl₃, NaAlF₆ and LiAlF₄.

3. A method of claim 1, said additives mix together homogeneously with active nickel oxide or may form solid solution in the body of nickel oxide powders before or during the slurry preparation.

4. A method of claim 1, wherein a 0.1 to 3 wt. % of alkaline solution may be added during the slurry preparation.

5. A method of claim 1, the amount of said metal halides and oxides is 0.05-10 wt. %.

6. A method of claim 1, the amount of said metal halides and oxides is 0.1-5.0 wt. %.

7. A method of claim 1 wherein said impregnation machine is a tvo-plate assembly which is made of metal such as stainless steel and aluminum, or plastic material such as PVC, polypropylene, polysulfone and polyamide; said impregnation machine comprises one slot as the inlet and outlet for said substrate, one inlet and one or more outlet(s) for the slurry, and two or more paths (reservoir spaces) which deliver the slurry evenly throughout said substrate.

8. A nickel electrode made in accordance with the method of claim 1.

9. A method to make a high capacity nickel hydride battery, said method comprises:
(1) preparing a hydrogen storage electrode as a negative electrode of said battery,
(2) preparing a nickel electrode having an electrochemical capacity from 0.45 to 0.75 AH/cc as a positive electrode,
(3) providing a separator,
(4) providing an electrolyte,
(5) providing a container, and
(6) assembling a rechargeable hydride battery, comprising the steps of:
placing said separator between said negative and positive electrodes,
placing said separator and said positive and negative electrodes in said container, and
placing said electrolyte in said container in contact with said negative and positive electrodes and with said separator;
wherein said positive electrode at least comprises a nickel hydroxide plus 1-15 wt. % of fine additive powders selected from the group consisting of cobalt oxide, Ni, Co, Cu, Zn, ZnO, C, Mg, Al, Mn, silver oxide, iodine, iodide (LiI, NaI, KI, etc.), hydride, conductive polymer, and combinations thereof, wherein said positive electrode further comprises one, two or more additives, 0.01-10 wt. %, selected from the group of MgCl₂, CaCl₂, SrCl₂, SrF₂, BaCl₂, BaF₂, MgF₂, and other fluorides/chlorides of Li, Na. K, Rb, Cs, Be, Mg, Sr, Ba, Al, B, Bi, Sb, Y, Ag, Ti, Zr, V, Nb, Cr, Mn, Mo, Zn, Cu, Ni, Co, rare earth metals, and composite metal oxide/halide to improve the performance of said positive electrode at high temperature.

10. A method of claim 10, wherein said metal fluorides and chlorides comprise CaCl₂, SrCl₂, SrF₂, BaCl₂, BaF₂, MgCl₂, MgF₂, ZnCl₂, ZnF₂, AlCl₃, AlF₃, KCl, KF, NaCl, NaF, LiCl, LiF, BiCl₃, NaAlF₆ and LiAlF₄.

11. A method of claim 10, wherein said metal fluorides and chlorides are MgCl₂, CaCl₂, SrCl₂, SrF₂, BaCl₂, ZnCl₂, AlCl₃, MgF₂, ZnF₂, AlF₃, KCl, KF, NaCl, NaF, LiCl, LiF, BiCl₃, NaAlF₆ and LiAlF₄.

12. A method of claim 10, wherein said electrolyte comprises KOH solution with concentration from 20 to 45 wt. % plus 0 to 10 wt. % of LiOH.

13. A method of claim 10, wherein said electrolyte further comprise NaOH solution.

14. A method of claim 10, wherein said electrolyte further comprise 0-10 wt. % of other chemicals selected from the group of alkali iodide, NaOH, Ca(OH)₂, Mg(OH)₂, Sr(OH)₂, Be(OH)₂, ZnO, Al₂O₃ or the combinations thereof.

15. A high capacity nickel hydride battery, said battery comprises:
(1) hydrogen storage electrode as a negative electrode,
(2) a nickel electrode as a positive electrode,
(3) a separator,
(4) an electrolyte, and
(5) a container;
wherein said separator between said negative and positive electrodes, placing said separator and said positive and negative electrodes in said container, and placing said electrolyte in said container in contact with said negative and positive electrodes and with said separator; wherein said positive electrode at least comprises a nickel hydroxide plus 1-15 wt. % of fine additive powders selected from the group consisting of cobalt oxide, Ni, Co, Cu, Zn, ZnO, C, Mg, Al, Mn, silver oxide, iodine, iodide (LiI, NaI, KI, etc.), hydride, conductive polymer, and combinations thereof; wherein said positive electrode further comprises one, two or more additives, 0.01-10 wt. %, selected from the group of MgCl₂, CaCl₂, SrCl₂, SrF₂, BaCl₂, BaF₂, MgF₂, and other fluorides/chlorides of Li, Na. K, Rb, Cs, Be, Mg, Sr, Ba, Al, B, Bi, Sb, Y, Ag, Ti, Zr, V, Nb, Cr, Mn, Mo, Zn, Cu, Ni, Co, rare earth metals, and composite metal oxide/halide to improve the performance of said positive electrode at high temperature.

16. A battery of claim 16, wherein said additive of said positive electrode are MgCl₂, CaCl₂, SrCl₂, SrF₂, BaCi₂, BaF₂, MgF₂, and other fluorides/chlorides of Li, Na. K, Rb, Cs, Be, Mg, Sr, Ba, Al, Y, Mn, Zn and rare earth metals.

17. A battery of claim 16, wherein said electrolyte comprises KOH solution with concentration from 20 to 45 wt. % plus 0 to 10 wt. % of LiOH.

18. A battery of claim 16, wherein said electrolyte further comprise NaOH solution.

19. A battery of claim 16, wherein said electrolyte further comprise 0-10 wt. % of other chemicals selected from the group of alkali iodide, NaOH, Ca(OH)₂, Mg(OH)₂, Sr(OH)₂, Be(OH)₂, ZnO, Al₂O₃ or the combinations thereof.

20. A battery of claim 16, wherein said negative electrode comprises hydrogen storage alloys selected from Ti/Zr based and/or rare earth-based alloys.
